(19) United States
(12) Patent Application Publication
(10) Pub. No.: US 2011/0030499 A1
(43) Pub. Date: Feb. 10, 2011

(54) Adjustable Pulley Assembly

(76) Inventors: Steven J. Benda, Cokato, MN (US); Dorothy C. Ruohonen, Atlantic Mine, MI (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 12/537,905

(22) Filed: Aug. 7, 2009

(51) Int. Cl. F16L 3/015; F16L 3/00; F16C 1/10; B23P 11/00

(52) U.S. Cl. 74/502.4; 248/49; 29/428

(57) ABSTRACT

An adjustable pulley assembly is provided for operably and reliably routing a line through one or more non-perpendicular angles of a line activated system, while maintaining a closed environment as the line changes directions. Some embodiments provide an adjustable pulley assembly having first and second housing members rotationally engaged about an axis of rotation to provide an angular separation between adjacent conduits coupled to the pulley assembly. In some cases the angular separation is adjustable within a range of angles including and extending between a minimum separation angle and a maximum separation angle. Systems and methods incorporating the adjustable pulley assembly are also provided.

### BACKGROUND

Line activated systems are commonly available in a variety of fields to provide for remote, manual activation of one or more components of a system. Line activated systems typically include a pull lever, knob, or other such actuator readily accessible to an operator. The actuator is coupled to a line (e.g., a wire, cable, chain, rope, etc.), which is in turn coupled to one or more components of the system that are (relatively) remote from the operator. A routing system (e.g., conduit and/or pulleys) usually routes the line between the pull lever and the remote components to be actuated.

One common example of a line activated system is a remote activated fire suppression system. For example, referring to FIG. 1, a representation of a prior art line activated fire suppression system 10 is shown. The line activated fire suppression system 10 generally includes a line 12 coupled between a pull lever 14 and a fire suppression dispenser 16. Typically the pull lever 14 is located within arm's reach of an operator of a machine, such as, for example, an oil fryer, an oven, a grill, a popcorn machine, etc., and the fire suppression dispenser 16 is located remotely from the machine. In the event of a fire near the machine, the operator can pull the pull lever 14, thereby activating a release mechanism of the fire suppression dispenser 16. The fire suppression dispenser 16 then releases a fire suppression agent to counteract the fire. For example, the fire suppression dispenser 16 may release a flame retardant foam, carbon dioxide, and/or other fire suppression agents, as appropriate, to extinguish the fire.

Line activated systems can employ a variety of different routing systems to guide the line between the pull lever and the component to be actuated. In some cases a small pre-shaped rigid conduit may be used where designs and component dimensions are known and fixed. The pre-shaped rigid tubing may be constructed using aluminum or stainless steel for example, to ensure that in the event of a fire, the conduit is non-flammable and will function as designed under high heat conditions. However, as the line is pulled through the pre-shaped conduit, the line can often encounter a high degree of friction as it travels around bends and curves in the conduit.

In other systems, a line can be routed between the pull lever and the release mechanism along a predetermined path defined by specific pulley systems located at each change in line direction. However, a simple loss of line tension can result in the line “jumping its pulley,” thus resulting in failure of the line activated system. In addition, the line and pulley systems can be adversely affected under high heat conditions since the pulley systems are typically open to the surrounding environment.

Referring again to FIG. 1, in some cases a line activated system can include a rigid conduit system with one or more fixed pulley elbows 20 coupling adjacent conduit sections to change the direction of the line path between the pull lever 14 and the release mechanism. While these fixed pulley elbows 20 can change the line direction, line path configurations are limited by the fixed design of the pulley elbow 20, which only allow 90 degree turns in the line path. Accordingly, these types of routing systems only provide a limited variety of configurations for line activated systems. These fixed routing paths can not be adapted to accommodate some building wall geometries, wall hanging interruptions, accesses, and the like.

Therefore, what is needed is an easily configurable and reliable system for routing a line within a line activated system.

### SUMMARY

Embodiments of the invention relate to line activated systems, and devices and methods for manually routing a line through a line activated system. Embodiments of the invention provide devices and methods for operably and reliably routing a line through one or more non-perpendicular angles with minimal friction, while maintaining a closed environment in the line activated system.

According to one aspect of the invention, embodiments provide an adjustable pulley assembly capable of routing a line within a line activated system. The pulley assembly includes a housing having at least a first housing member and a second housing member. The first housing member has a first aperture that allows access between the housing and a first conduit of the line activated system and the second housing member has a second aperture that allows access between the housing and a second conduit of the line activated system. In some cases the first and second housing members are rotationally engaged about an axis of rotation, thus providing an angular separation between the first aperture and the second aperture. The angular separation is preferably adjustable within a range of angles including and extending between a minimum separation angle and a maximum separation angle. In addition, in some cases the housing provides an enclosed compartment connecting the first and second apertures throughout the range of angles. Among other components, the adjustable pulley assembly includes a pulley member disposed within the enclosed compartment about the axis of rotation. The pulley member can route a line through the housing between the first and second conduits. The line usually extends through the first and second conduits for activating the line activated system.

According to another aspect of the invention, a line or wire activated system is provided, including a closed conduit network. The network includes an adjustable pulley assembly according to embodiments of the invention, at least a first conduit coupled to a first aperture of the adjustable pulley assembly, and at least a second conduit coupled to the second aperture of the adjustable pulley assembly. In some cases the second conduit is oriented at a non-perpendicular angle with respect to the first conduit. A line can extend through the closed conduit network for activating the wire activated system, wherein the adjustable pulley assembly directs the line around the non-perpendicular angle between the first and second conduits.

In another aspect of the invention, a method of installing a fire alarm and/or suppression system is provided. The method includes providing an adjustable pulley assembly having a housing and a pulley member disposed within the housing. The housing comprises a first housing member having a first aperture and a second housing member having a second aperture. In some cases the first and second housing members are rotationally engaged to provide an angular separation between the first and second apertures, and the housing provides an enclosed compartment connecting the first and second apertures. The method further includes adjusting the angular separation between the first and second apertures of the adjustable pulley assembly to a desired non-perpendicular angle and coupling a first conduit to the first aperture and coupling a second conduit to the second aperture. A line is coupled to a system actuator, and the line is routed through the first conduit, the adjustable pulley assembly, and the second conduit to allow remote activation of the fire alarm and/or suppression system.

### BRIEF DESCRIPTION OF THE DRAWINGS

The following drawings are illustrative of particular embodiments of the present invention and therefore do not limit the scope of the invention. The drawings are not to scale (unless so stated) and are intended for use in conjunction with the explanations in the following detailed description. Embodiments of the present invention will hereinafter be described in conjunction with the appended drawings, wherein like numerals denote like elements.

FIG. 1 is a representation of a prior art line activated system.

FIG. 2 is schematic of a line activated system according to some embodiments of the present invention.

FIG. 3A is a perspective view of an adjustable pulley assembly coupled between two conduits according to some embodiments of the present invention.

FIG. 3B is a side view of the adjustable pulley assembly of FIG. 3A.

FIG. 4 is a partial cut-away view of an adjustable pulley assembly coupled between two conduits according to some embodiments of the present invention.

FIG. 5 is an exploded perspective view of the adjustable pulley assembly of FIG. 4.

FIG. 6 is an assembly view of the adjustable pulley assembly of FIG. 3A.

FIG. 7A is a perspective view of a housing member of an adjustable pulley assembly according to some embodiments of the present invention.

FIG. 7B is a top view of the housing member of FIG. 7A.

FIG. 7C is a sectional view of the housing member of FIG. 7B taken along line BB.

FIG. 7D is a first side view of the housing member of FIG. 7A.

FIG. 7E is a second side view of the housing member of FIG. 7A.

FIG. 8A is a top perspective view of a housing member of an adjustable pulley assembly according to some embodiments of the present invention.

FIG. 8B is a bottom perspective view of the housing member of FIG. 8A.

FIG. 8C is a top view of the housing member of FIG. 8A.

FIG. 8D is a sectional view of the housing member of FIG. 8C taken along line BB.

FIG. 8E is a side view of the housing member of FIG. 8A.

FIG. 8F is a bottom view of the housing member of FIG. 8A.

FIG. 9A is an enlarged bottom perspective view of the housing member of FIG. 8A showing a friction surface according to some embodiments of the invention.

FIG. 9B is a perspective, sectional view of the friction surface shown in FIG. 9A.

FIG. 9C is a side sectional view of the friction surface shown in FIG. 9A.

FIG. 10 is a partial exploded, assembly cross-sectional view of an adjustable pulley assembly according to some embodiments of the invention.

FIG. 11A is a cross-section of the adjustable pulley assembly of FIG. 10 illustrating a first engagement of friction surfaces.

FIG. 11B is a cross-section of the adjustable pulley assembly of FIG. 10 illustrating a second engagement of friction surfaces.

FIG. 12 is a top view of the adjustable pulley assembly of FIG. 3A illustrating a range of angles according to some embodiments of the invention.

FIG. 13A is a top view of an adjustable pulley assembly adjusted to a maximum separation angle according to some embodiments of the invention.

FIG. 13B is a top sectional view of the adjustable pulley assembly of FIG. 13A.

FIG. 14A is a top view of an adjustable pulley assembly adjusted to a separation angle according to some embodiments of the invention.

FIG. 14B is a top sectional view of the adjustable pulley assembly of FIG. 14A.

FIG. 15A is a top view of an adjustable pulley assembly adjusted to a minimum separation angle according to some embodiments of the invention.

FIG. 15B is a top sectional view of the adjustable pulley assembly of FIG. 15A.

FIGS. 16A-16C illustrate various views of an adjustable pulley assembly washer according to some embodiments of the invention.

FIGS. 17A-17C illustrate various views of a set screw conduit fitting of an adjustable pulley assembly according to some embodiments of the invention.

FIGS. 18A-18C illustrate various views of an internally-threaded conduit fitting of an adjustable pulley assembly according to some embodiments of the invention.

FIGS. 19A-19C illustrate various views of an externally-threaded conduit fitting of an adjustable pulley assembly according to some embodiments of the invention.

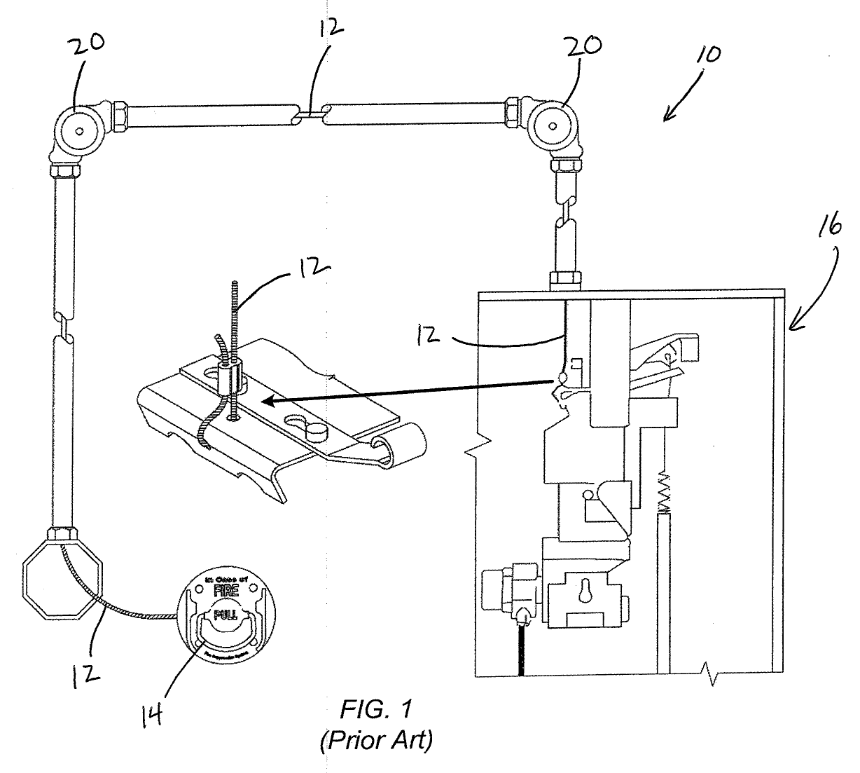

### DETAILED DESCRIPTION OF THE PREFERRED EMBODIMENTS

The following detailed description is exemplary in nature and is not intended to limit the scope, applicability, or configuration of the invention in any way. Rather, the following description provides practical illustrations for implementing exemplary embodiments of the present invention. Examples of constructions, materials, dimensions, and manufacturing processes are provided for selected elements, and all other elements employ that which is known to those of skill in the field of the invention. Those skilled in the art will recognize that many of the examples provided have suitable alternatives that can be utilized.

Embodiments of the invention provide devices, systems, and/or techniques for routing lines (e.g., wires, cables, chains, ropes, etc.) through various line paths with a variety of configurations and geometries. Advantageously, embodiments including various pulley assemblies can provide such routing in an operable and reliable manner. In addition, some embodiments of the invention provide adjustable components that allow multiple configurations of a line path, while also maintaining the integrity of the closed environment required in some situations. Thus, some embodiments of the invention provide numerous advantages for various types of line activated systems. Embodiments of the invention are not limited to line activated systems, though, and may also be useful for other types of systems that include a line that changes directions along its line path.

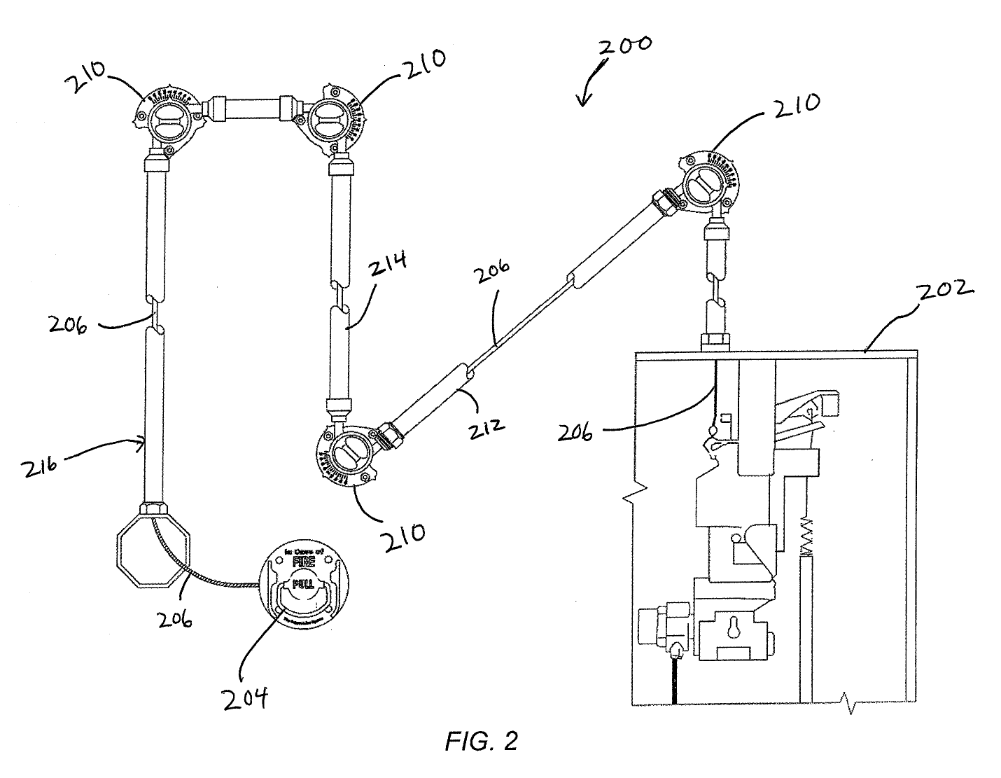

Turning now to FIG. 2, a schematic of a line activated system 200 is shown according to some embodiments of the invention. Embodiments of the invention may be useful for a variety of line activated and other systems. As just one example, the line activated system 200 of FIG. 2 provides remote activation of a fire suppression system. In this example, the line activated system 200 includes a fire suppression dispenser 202 that is coupled to a remote pull lever 204 by a line 206. By actuating the pull lever 204, an operator can remotely activate the fire suppression dispenser 202 in order to extinguish a fire. For example, the pull lever 204 may be located proximate to a machine such as an oil fryer, an oven, a grill, a popcorn machine, etc. In the event of a fire near the machine, the operator can pull the pull lever 204 coupled to a first end of the line 206, which then actuates a release mechanism of the fire suppression dispenser 202 coupled to a second end of the line 206. The fire suppression dispenser 202 then releases a fire suppression agent to counteract the fire.

In many instances, the design and layout of an environment can present challenges in routing a line activated system. For example, pre-existing infrastructure such as walls, overhangs, partitions, ducts, pipes, etc., as well as large and otherwise immovable equipment can obstruct a desired line path for a line activated system. Referring again to FIG. 2, embodiments of the invention provide an adjustable pulley assembly 210 that allows for easy redirection of a line path around obstacles with minimal friction. As will be further discussed, the adjustable pulley assembly 210 provides for a wide variety of redirection angles beyond the traditional right angles afforded by past elbows and/or pulleys. For example, the adjustable pulley assembly 210 may be adjusted to any one of a number of non-perpendicular angles.

Further, in some embodiments, the adjustable pulley assembly 210 can provide a closed transition or path between adjacent conduits, thus preserving the environmental containment of closed conduit network. For example, the adjustable pulley assembly 210 can be coupled between a first conduit 212 and a second conduit 214 in a closed conduit network 216 to route the line 206 about a non-perpendicular angle with respect to the first conduit 212. Thus, embodiments of the invention provide an improved pulley assembly 210 that can provide an enclosed transition between conduits. Embodiments of the invention increase reliability over “open pulleys” in that it is more difficult for the line 206 to “jump the pulley.” In addition, the integrity of the closed conduit network 216 is maintained between the first and second conduits 212, 214. Thus in some embodiments, the pulley members, including low-friction ball bearing pulleys, are protected from the external environment within the enclosed pulley assembly.

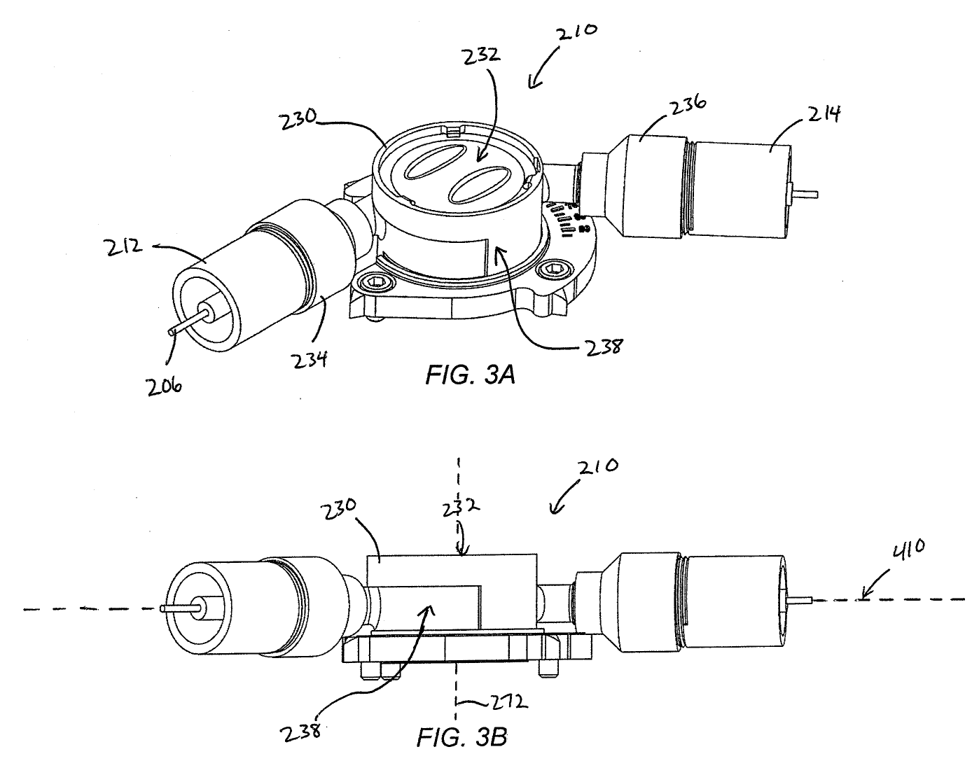

FIGS. 3A and 3B show, respectively, perspective and side views of an adjustable pulley assembly 210 coupled between a first conduit 212 and a second conduit 214 according to some embodiments of the present invention. The pulley assembly 210 generally includes a housing 230 that provides an enclosed compartment 232, and thus a closed transition for routing the line 206 between the first and second conduits 212, 214. In some embodiments the pulley assembly 210 includes first and second conduit fittings 234, 236 for coupling the pulley assembly to the first and second conduits. In addition, in some embodiments the housing 230 includes an adjustable side wall 238 that can adjust as an angular separation between the first and second conduits 212, 214 changes. Thus, the pulley assembly 210 can be adjusted to provide a plurality of angles between adjacent conduits while also maintaining a closed transition between the conduits.

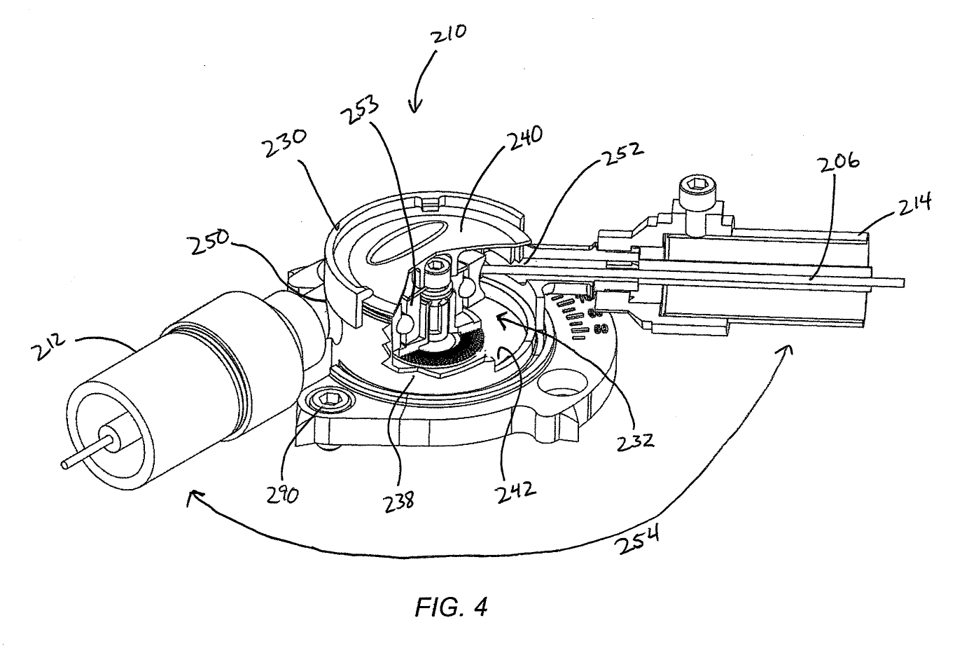

Turning now to FIG. 4, a partial cut-away view is shown illustrating the interior of the pulley assembly 210 according to some embodiments. In addition to the adjustable side wall 238, in some cases the housing 230 includes a top wall 240 and a bottom wall 242 defining the enclosed compartment 232. The housing 230 also includes a first aperture 250 providing access between the enclosed compartment 232 and the first conduit 212 and a second aperture 252 providing access between the enclosed compartment 232 and the second conduit 214 of the line activated system. Thus when the pulley assembly 210 is coupled to the first and second conduits, the enclosed compartment 232 and the first and second apertures 250, 252 provide a closed transition between the first and second conduits, advantageously maintaining the environmental integrity of the conduit network. A pulley member 253 disposed within the enclosed compartment can route the line 206 between the first and second apertures 250, 252.

In some embodiments the first and second apertures 250, 252 are generally aligned coaxially with the first and second conduits 212, 214, respectively. As shown in FIG. 4, an angular separation 254 defined between the first and second apertures 250, 252 also generally corresponds to the angular separation between the first and second conduits 212, 214. As will be described in detail, in some embodiments, the pulley assembly 210 and the angular separation 254 is adjustable within a range of angles. For example, the angular separation 254 is not limited to a single pre-defined angle (as with a right angle joint), but may include a range of angles including and extending between a minimum separation angle and a maximum separation angle.

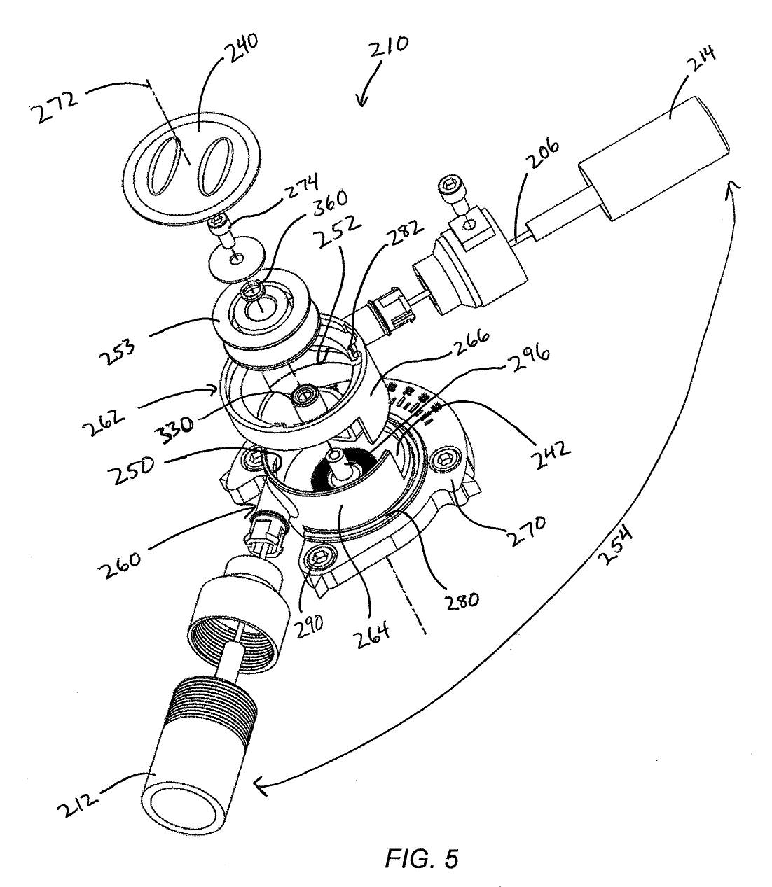

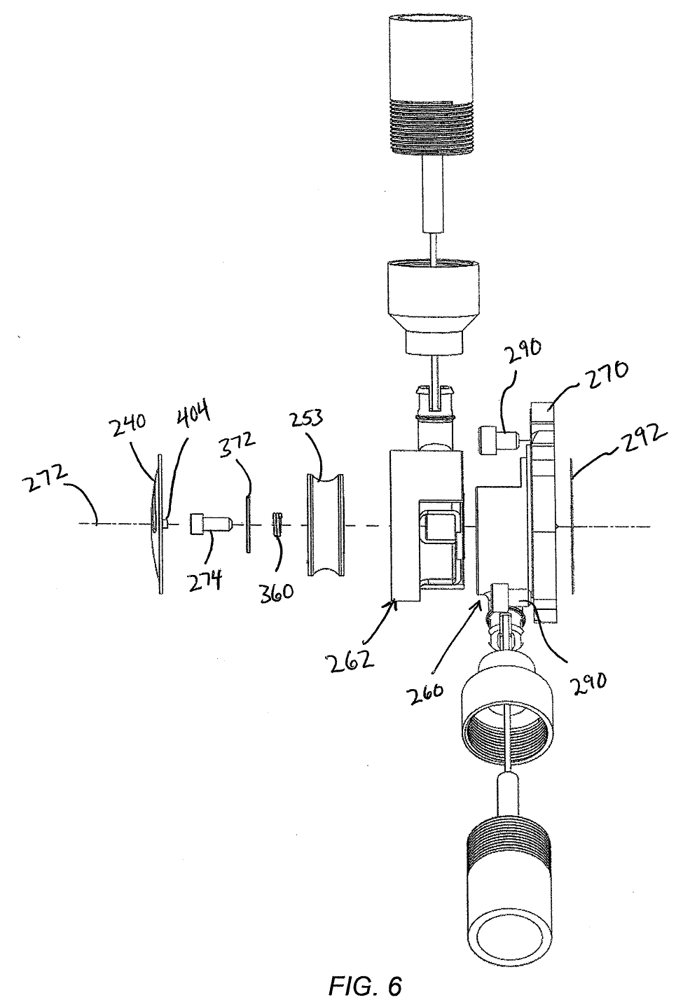

FIG. 5 shows an exploded perspective view of the pulley assembly 210 according to some embodiments of the invention. FIG. 6 shows a similar assembly view of the adjustable pulley assembly 210 from a side view. As shown in FIG. 5, in some cases the housing 230 of the pulley assembly is formed from two or more components. For example, in some embodiments, the housing 230 includes a first housing member 260 and a second housing member 262 that operatively couple together to form the adjustable enclosed compartment 232. Continuing to refer to FIG. 5, the first housing member 260 includes a first wall portion 264 that defines and includes the first aperture 250 that accesses the first conduit 212. Similarly, the second housing member 262 includes a second wall portion 266 that includes the second aperture 252 that accesses the second conduit 214.

In some embodiments the first housing member 260 includes the bottom wall 242 of the housing 230. For example, as shown in FIG. 5, the bottom wall 242 can be an integral portion of a mounting plate 270 that assists in fixing the pulley assembly 210 to a support surface. In some embodiments the second housing member 262 includes the top wall 240 of the housing 230. The top wall 240 can manufactured as an integral part of the second housing member 262, or as shown in FIG. 5, may comprise a removable portion of the second housing member 262.

As can be seen in FIG. 5, as the first and second housing members 260, 262 are coupled together along a common axis 272, the respective walls and wall portions of the housing members combine to form the enclosed compartment 232. For example, when coupled (e.g., with a fastener 274), the first and second housing members are preferably arranged so that the first wall portion 264 overlaps and slidingly engages the second wall portion 266, thus forming the adjustable sidewall 238 of the housing 230. Accordingly, in some embodiments the first and second housing members can completely enclose about the pulley member 253 disposed within the enclosed compartment 232. In some embodiments, the pulley member 253 may also be disposed about the common axis of rotation 272.

In some embodiments, the first and second housing members 260, 262 are rotationally engaged about the common axis of rotation 272 to provide the housing and pulley assembly with some measure of angular adjustability. Referring to FIG. 5, the rotational engagement of the first and second housing members defines the angular separation 254 between the first and second apertures 250, 252 of the housing. Accordingly, rotating the first housing member 260 about the axis 272 with respect to the second housing member 262 also adjusts the angular separation 254 between the first and second apertures 250, 252, as well as the first and second conduits 212, 214 coupled to the pulley assembly 210. Thus, the angular separation 254 is adjustable within a range of angles.

According to some embodiments, the pulley assembly 210 advantageously maintains the integrity of the enclosed compartment 232 as the angular separation 254 is adjusted throughout the range of angles. For example, in some embodiments, the first wall portion 264 continuously overlaps with the second wall portion 266 to a greater or lesser extent throughout the range of angles. Additionally, in some embodiments the first wall portion 264 engages with the second housing member 262 and/or the second wall portion 266 engages with the first housing member 260 to further seal the enclosed compartment 232. For example, in some cases the first housing member 260 includes a first retention member 280 that retains an edge of the second wall portion 266 in the sliding engagement. Similarly, in some cases the second housing member includes a second retention member 282 that retains an edge of the first wall portion 264 in the sliding engagement. In some embodiments the retention members comprise grooves in the housing members into which the edges of the wall portions fit and slide.

As previously discussed, in some embodiments the housing 230 includes a mounting plate 270 to assist in mounting the pulley assembly 210 to a support surface. As shown in FIGS. 4 and 5, the mounting plate 270 can in some cases include one or more screw bosses and mounting screws 290 to attach the mounting plate to a support surface. Turning to FIG. 6, in some embodiments, an adhesive 292, such as an adhesive tape, can also be placed on the back of the mounting plate 270 to affix the mounting plate in place of or in addition to the mounting screws 290.

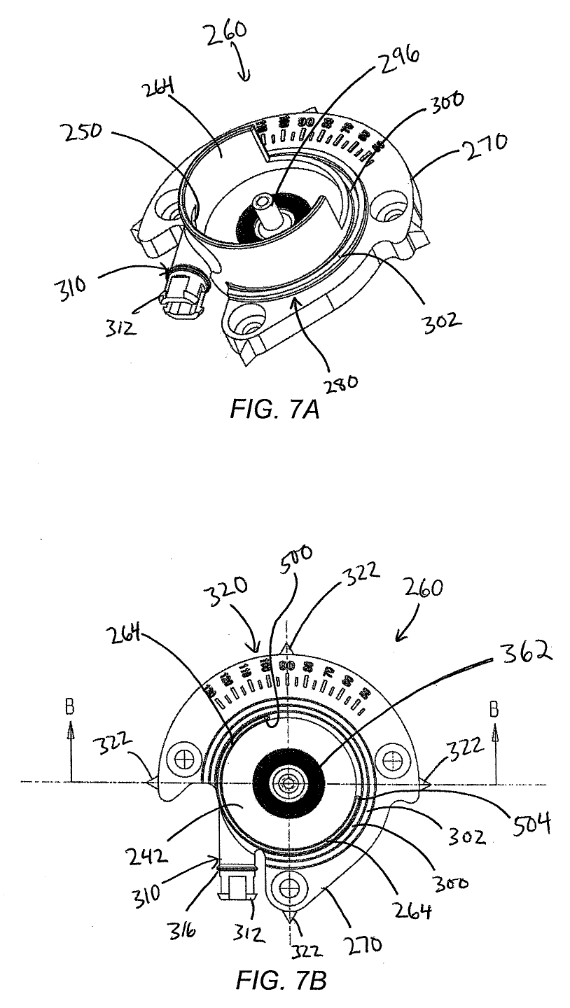

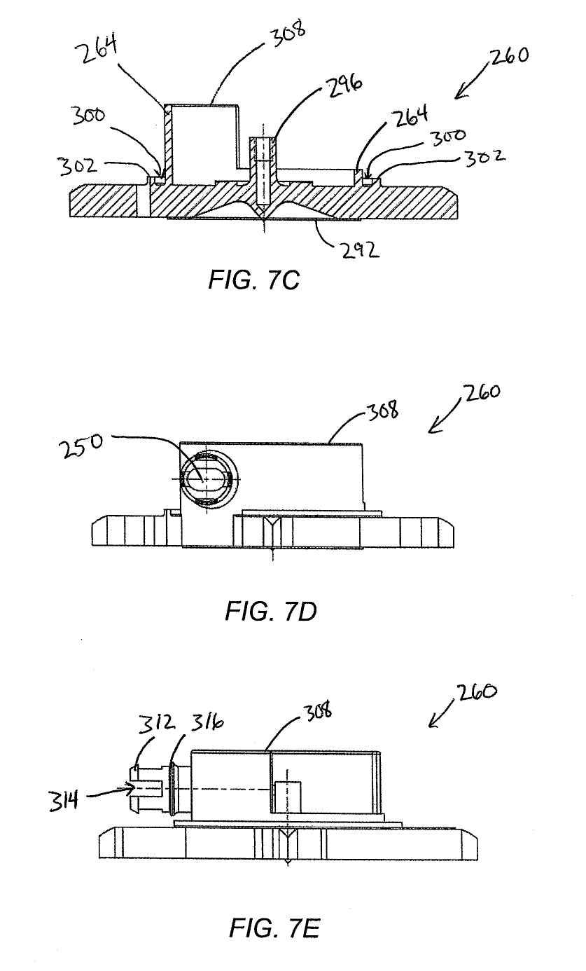

Turning to FIGS. 7A-7E, several views of the first housing member 260 are shown according to some embodiments of the invention. For example, FIG. 7A illustrates a perspective view of the first housing member 260 and FIG. 7B illustrates a top view. In some embodiments, the first housing member 260 includes a lower support post 296 for supporting the pulley member 253 and/or the second housing member 262. For example, as shown in FIGS. 7A and 7C, the lower support post 296 can in some cases protrude from the bottom wall 242 of the housing along the axis of rotation 272. Thus, in some cases the pulley member can be supported within the enclosed compartment about the post 296 and the axis of rotation 272.

As previously described, in some embodiments the first retention member 280 comprises a groove adapted to slidingly engage the second wall portion of the second housing member. For example, the first retention member 280 can in some cases be formed from a middle raceway 300 defined between the first wall portion 264 and an outer raceway 302. Preferably the middle raceway 300 follows the contour of the first wall portion 264 to provide a close overlapping engagement between the first and second wall portions. Thus, in some cases an edge of the second wall portion 266 can engage the middle raceway 300 tongue-in-groove, providing a substantially closed engagement and maintaining the environmental integrity of the enclosed compartment 232. In a similar manner, in some embodiments, the first wall portion 264 has an upper edge 308 that can engage the second retention member of the second housing member as will be described below.

In some embodiments of the invention, the first housing member 260 includes a first conduit fitting boss 310 positioned at the first aperture 250, which enables the housing member to couple with one or more types of conduit fittings as shown in FIG. 5. For example, the conduit fitting boss 310 may be a type of universal fitting designed to snap fit into a variety of conduit fittings. Referring to FIGS. 7A, 7B, and 7E, in some embodiments, the first conduit fitting boss 310 includes a conduit fitting cleat 312, a conduit fitting relief 314, and a conduit fitting stop 316. As will be described in more detail, one or more universal conduit fittings can be snap fit onto the universal conduit fitting bosses. The conduit relief areas 314 allows a slight compression of the boss tip to enable insertion of the tip into the conduit fitting. Once compressed and inserted, the conduit fitting cleat 312 expands and locks the boss tip into the conduit fitting, with the conduit fitting pressed against the conduit fitting stop 316 resulting is a secure coupling of the conduit fitting to the fitting boss 310.

Referring to FIG. 7B, in some embodiments, the pulley assembly 210 can include an angular scale 320 to facilitate accurate and precise placement of the pulley assembly. For example, the angular scale 320 may be embossed, stamped, or otherwise included on a surface of the mounting plate 270. As will be discussed, in some embodiments the second housing member 262 includes an angular indicator that points to the angular scale 320. For example, the angular scale 320 and the angular indicator may be calibrated with the positions of the first and second apertures so that the angular indicator indicates the angular separation between the first and second apertures as the angular separation is adjusted. In some cases, the angular scale 320 may include references for a maximum separation angle and a minimum separation angle as will be discussed hereinafter.

In some embodiments the mounting plate 270 includes one or more mounting reference tabs 322 to aid in the installation of the pulley assembly 210. For example, referring to FIG. 7B, in some cases the mounting reference tabs 322 are configured at 90 degree increments from the 90 degree mark of the angular scale 320. Thus, the mounting reference tabs 322 can facilitate precise placement of the pulley assembly 210 to ensure that all pulley assemblies 210 and conduits in a closed conduit network are installed together with a great level of directional precision.

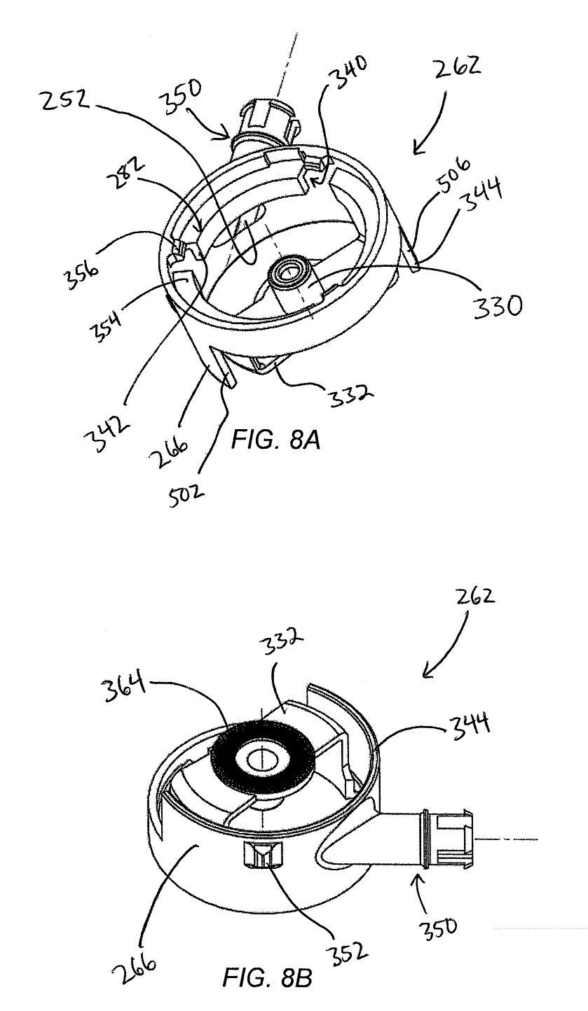

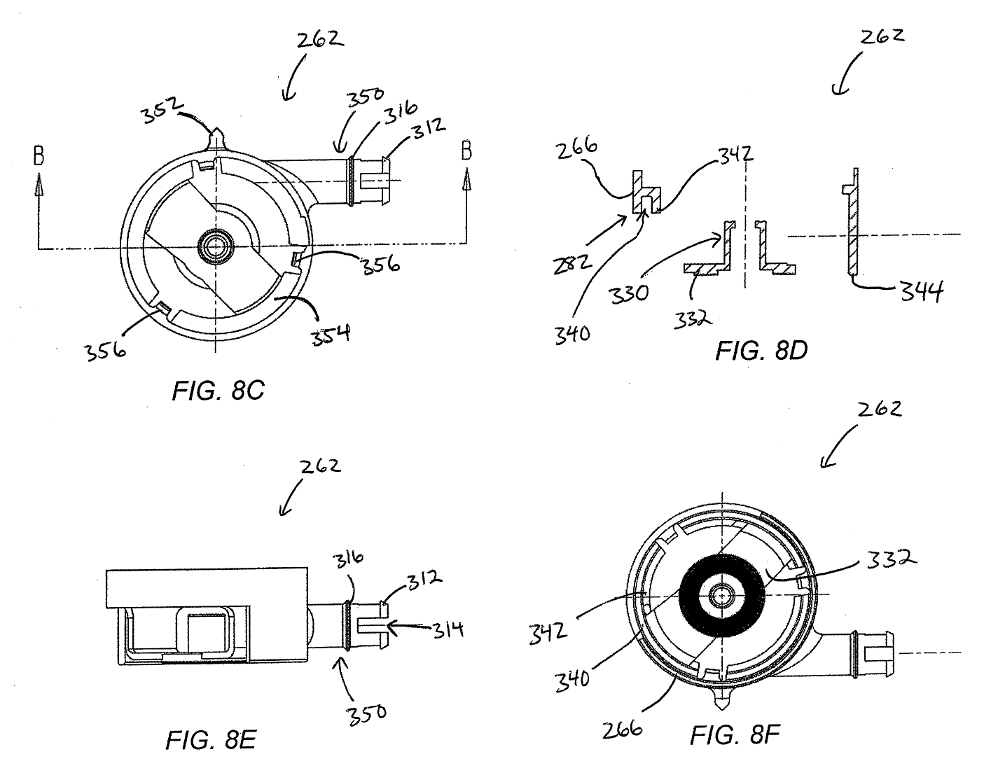

FIGS. 8A-8F illustrate various views of the second housing member 262 according to some embodiments. For example, FIG. 8A illustrates a top perspective view of the second housing member 262 and FIG. 8B illustrates a bottom perspective view. In some embodiments, the second housing member 262 includes an upper support post 330 for supporting the pulley member 253 and/or for engaging the lower support post 296 of the first housing member 260. For example, as shown in FIGS. 8A-8F, the upper support post 330 may extend upwards, coaxial with the axis of rotation 272, from a support shelf 332 suspended in the center of the second housing member. Thus, the pulley member can be supported within the enclosed compartment about the post 330 and the axis of rotation 272 and/or the upper support post 330 can be aligned and supported by the lower support post 296 of the first housing member.

As previously described, in some embodiments, the second retention member 282 can comprise a groove adapted to slidingly engage the first wall portion of the first housing member. For example, referring to FIGS. 8A, 8D and 8F, the second retention member 282 can in some cases be formed from a middle raceway 340 defined between the second wall portion 266 and an inner raceway 342. Preferably the middle raceway 340 follows the contour of the second wall portion 266 to provide a close overlapping engagement between the first and second wall portions. Thus, in some cases the edge 308 of the first wall portion 264 (as shown in FIGS. 7A-7E) can engage the middle raceway 340 tongue-in-groove, providing a substantially closed engagement and maintaining the environmental integrity of the enclosed compartment 232.

In a similar manner, in some embodiments, the second wall portion 266 has an upper edge 344 that can engage the first retention member 280 of the first housing member as previously described with reference to FIG. 7C.

In some embodiments of the invention, the second housing member 262 includes a second conduit fitting boss 350 positioned at the second aperture 252, which enables the housing member to couple with one or more types of conduit fittings as shown in FIG. 5. For example, the conduit fitting boss 350 may be a type of universal fitting designed to snap fit into a variety of conduit fittings. Referring to FIGS. 8C and 8D, in some embodiments, the second conduit fitting boss 350 includes a conduit fitting cleat 312, a conduit fitting relief 314, and a conduit fitting stop 316. As will be described in more detail, one or more universal conduit fittings can be snap fit onto the universal conduit fitting bosses. The conduit relief areas 314 allows a slight compression of the boss tip to enable insertion of the tip into the conduit fitting. Once compressed and inserted, the conduit fitting cleat 312 expands and locks the boss tip into the conduit fitting, with the conduit fitting pressed against the conduit fitting stop 316 resulting is a secure coupling of the conduit fitting to the fitting boss 310.

Referring to FIGS. 8B and 8C, in some embodiments the second housing member 262 includes an angular indicator 352 as previously discussed. The angular indicator 352 can be positioned so that as the angular separation of the pulley assembly is adjusted, the indicator points out the amount of current angular separation on the angular scale 320 on the first housing member (see FIG. 7A).

As previously discussed with reference to FIG. 5, in some embodiments, the second housing member 262 provides the top wall 240 of the housing in the form of a removable cover. Turning now to FIGS. 8A and 8C, in some embodiments the second housing member 262 includes a cover stop 354 and one or more cover cleats 356 that allow the removable cover 240 to be fixed to the top of the second housing member 262. As shown in FIG. 8A, the cover stop 354 may also be formed by a portion of the inner raceway 342 and/or middle raceway 340 in some cases.

Referring back to FIGS. 4 and 5, in some embodiments of the invention, the angular separation 254 of the adjustable pulley assembly 210 can be adjusted through a range of angles by rotating the first housing member 260 relative to the second housing member 262. In some embodiments, the housing members may be coupled together with varying degrees of resistance so that the angular separation 254 can be set and retained. For example, referring to FIG. 5, a fastener 274, such as a screw, inserted through the upper support post 330 and the lower support post 296, can couple the first and second housing members together along the axis of rotation 272. In some cases the force of the fastener may be adjustable to retain a current angular setting.

Some embodiments of the invention include a biasing member 360 (e.g., a spring) positioned along the axis of rotation 272 to urge the first and second housing members 260, 262 together. Thus, this spring force can allow relative rotation of the first and second housing members given sufficient force, but can also create sufficient frictional resistance between the first and second housing members to retain the members in a particular angular setting. For example, the biasing member 360 may create a frictional force between the first and second wall portions 264, 266, and the second and first retention members 282, 280, respectively.

Referring to FIGS. 7B and 8B, in some embodiments the first and second housing members 260, 262 include respective first and second friction surfaces 362, 364 that frictionally engage each other to set and retain the pulley assembly at any of the angles within the range of available separation angles. In some embodiments the friction surfaces provide a discrete number of angles within the range of angles, although a continuous range of an infinite number of angles may also be provided.

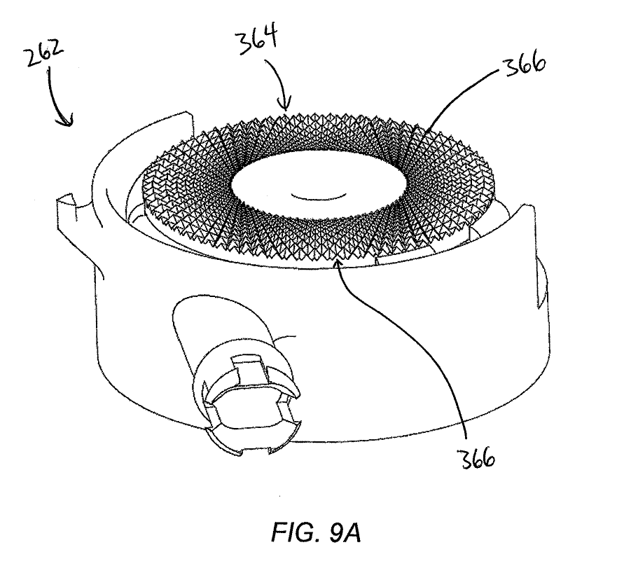

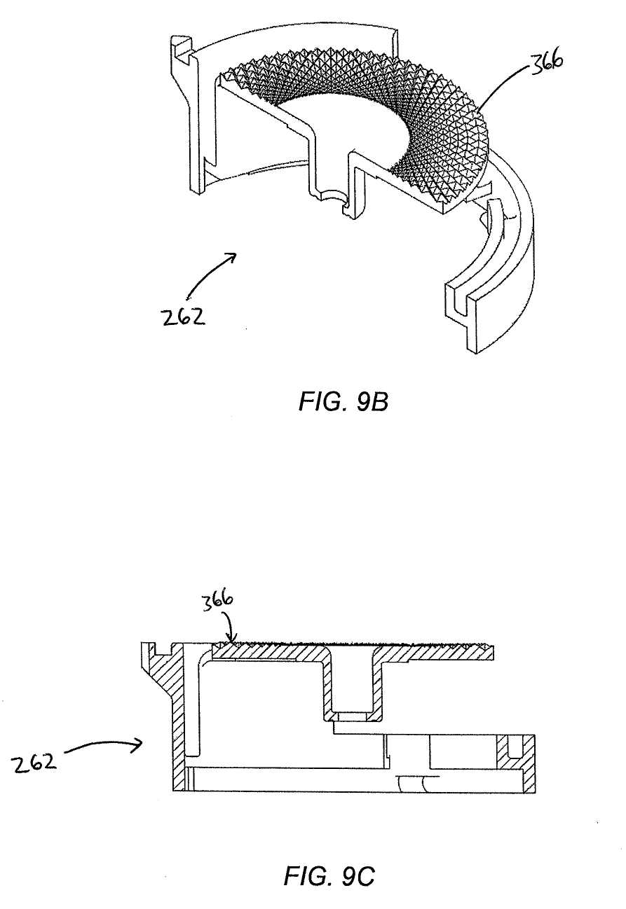

In some embodiments of the invention, one or more of the first and second friction surfaces 362, 364 can include one or more surface features to provide a discrete number of angles within the range of angles. For example, referring to FIGS. 9A-9C in which an enlarged view of the second friction surface 364 is depicted, the friction surfaces can in some instances have gear-like teeth 366 that allow the engaged first and second friction surfaces to move in metered and pre-defined angular increments. This metered ratchet mechanism between the first and second housing members 260, 262 allows an operator to precisely configure the pulley assembly 210 to have a desired angular separation. Such a mechanism thus can facilitate a precise layout a closed conduit network for more complex conduit routings.

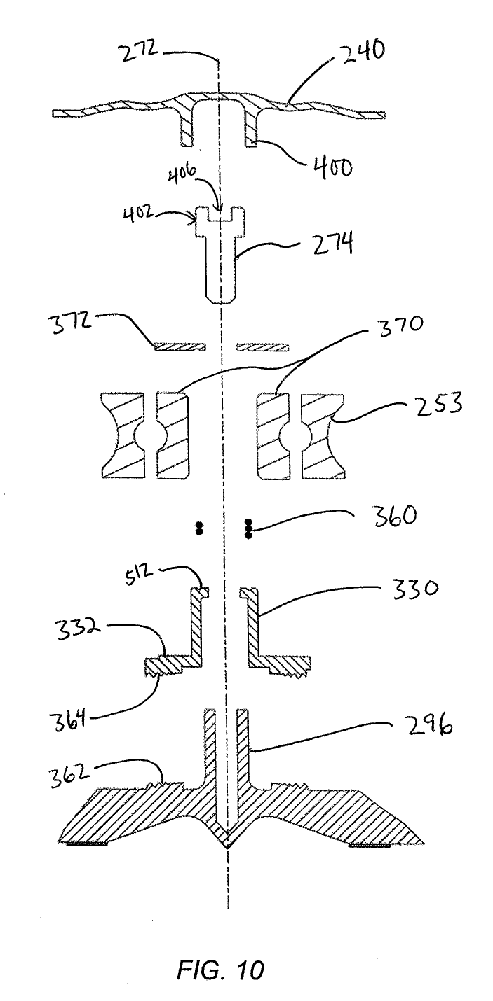

FIG. 10 illustrates a partial exploded, assembly cross-sectional view of the adjustable pulley assembly 210 according to some embodiments of the invention. In some embodiments the upper support post 330 is configured to slip over the lower support post 296 along the axis of rotation 272. Preferably, the inner diameter of the upper support post 330 and the outer diameter of the lower support post 296 are sized to enable rotational and axial movement between the first and second housing members 260, 262. In addition, the outer diameter of the upper support post 330 is preferably sized to engage the inner diameter of the pulley member 253 with a slight frictional fit. In some embodiments, an inner race 370 of the pulley member 253 engages the support shelf 332 to provide a stationary point to hold and secure the (e.g., ball bearing) pulley member 253.

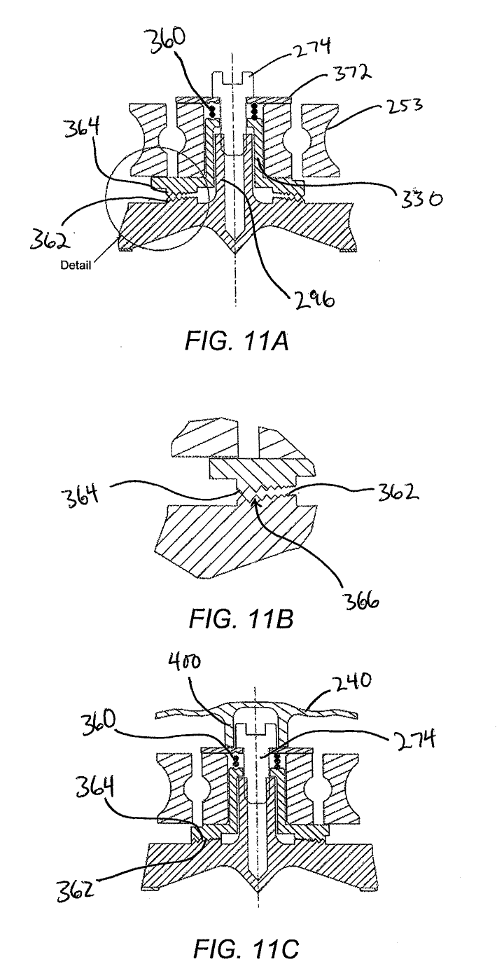

As depicted in FIG. 10, inserting the fastener 274 into the lower support post 296 introduces a downward force bearing directly on a washer 372, which in turn imposes a downward force on the biasing member 360. Turning to FIGS. 11A-11C, in some embodiments the biasing member 360 imposes a downward force on the second housing member 262, causing engagement of the first and second friction surfaces 362, 364. This downward force can cause the second housing member 262 and the first housing member 260 to ratchetly engage via the mating surfaces of the first and second friction surfaces 362, 364. Accordingly, a discrete number of angles within the range of angular separation angles can be provided.

FIGS. 11A-11C illustrate tooth-to-tooth ratcheting between the first and second friction surfaces 362, 364 as it occurs when each is rotated relative to the other according to some embodiments. Rotating the first housing member 260 relative to the second housing member 262 will cause the second friction surface 364 (and the second housing member 262) to move up and down slightly against the biasing member 360 as the surface features (e.g., gear teeth) of the friction surfaces move in and out of full engagement. FIG. 11A illustrates a first partial engagement of the friction surfaces 362, 364, with FIG. 11B showing the engagement in detail. FIG. 11C illustrates a second full engagement of the friction surfaces 362, 364 according to some embodiments of the invention.

In some embodiments of the invention, the pulley assembly 210 includes a unique alignment member that aids in aligning the various components of the pulley assembly 210 along the axis of rotation 272. For example, referring to FIGS. 10 and 11C, in some cases an alignment member 400 extends down from the top wall 240 (e.g., removable cover) to fix the fastener 274, the upper and lower support posts 330, 296, and the pulley member 253 along the axis of rotation 272. In some embodiments the alignment member 400 includes an enclosure member that can slip over the drive head 402 of the fastener 274. Referring to FIG. 6, in some embodiments the alignment member can comprise a pin 404 that slips into a central recess 406 of the fastener's drive head 402.

By ensuring that the fastener 274 and support posts 296, 330 are coaxial with the axis of rotation, the alignment member 400 can also ensure that the pulley member 253 rotates on a plane parallel to the line 206 being routed between conduits. For example, FIG. 3B shows one embodiment in which the centers of the first conduit 212 and the second conduit 214 (and additionally, although not shown, the first aperture 250 and the second aperture 252) are located within a plane 410 that is perpendicular to the axis of rotation 272. The coplanar rotation ensures that the pulley member 253 is correctly positioned to transfer the line 206 from the first conduit 212 to the second conduit 214 with minimal friction and slippage.

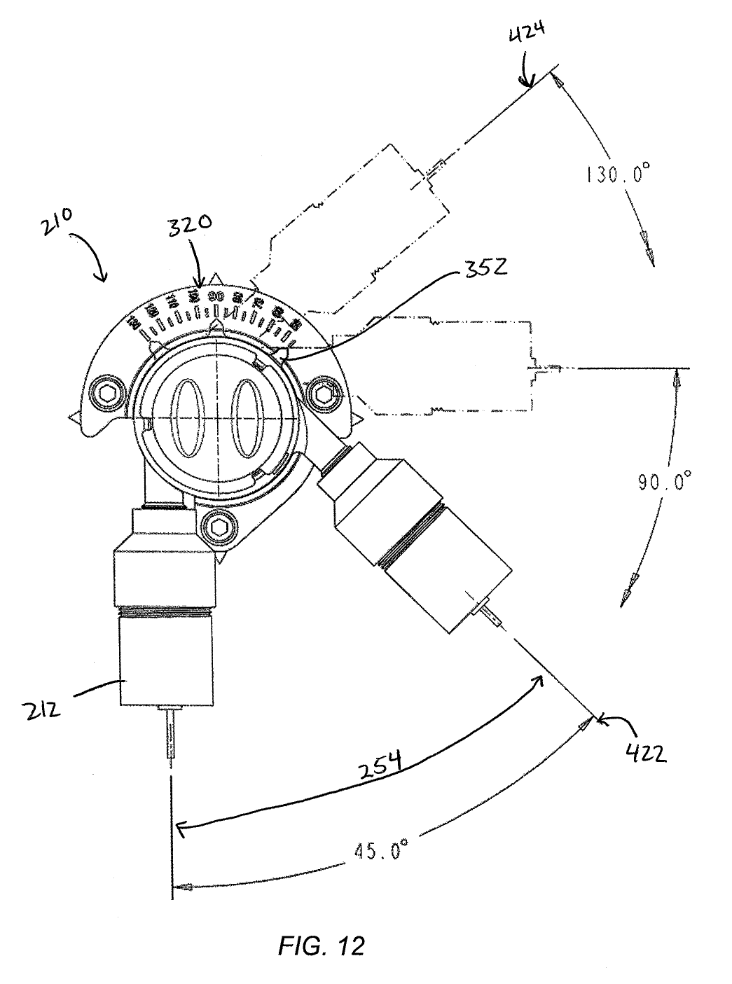

Turning now to FIG. 12, the pulley assembly 210 is shown in multiple optional configurations having different angular separations 254. Embodiments of the invention can provide a wide range of angular configurations for the pulley assembly 210 that include and extend between a minimum separation angle and a maximum separation angle. For example, in FIG. 12, a minimum separation angle 422 and a maximum separation angle 424 are illustrated with reference to the position of the first conduit 212. In some embodiments, the range of angles may span approximately 85 degrees. Some embodiments provide a minimum separation angle 420 about 45 degrees. In some embodiments a maximum separation angle 424 of about 130 degrees is provided. Of course other minimum and maximum separation angles, and ranges of angles, may be provided depending upon a particular embodiment.

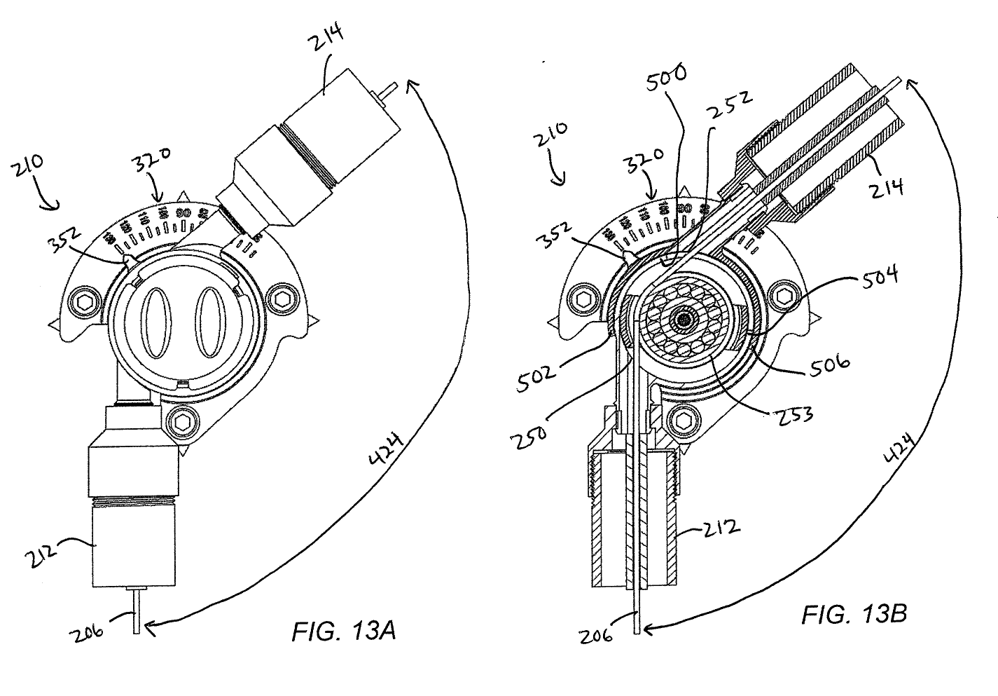

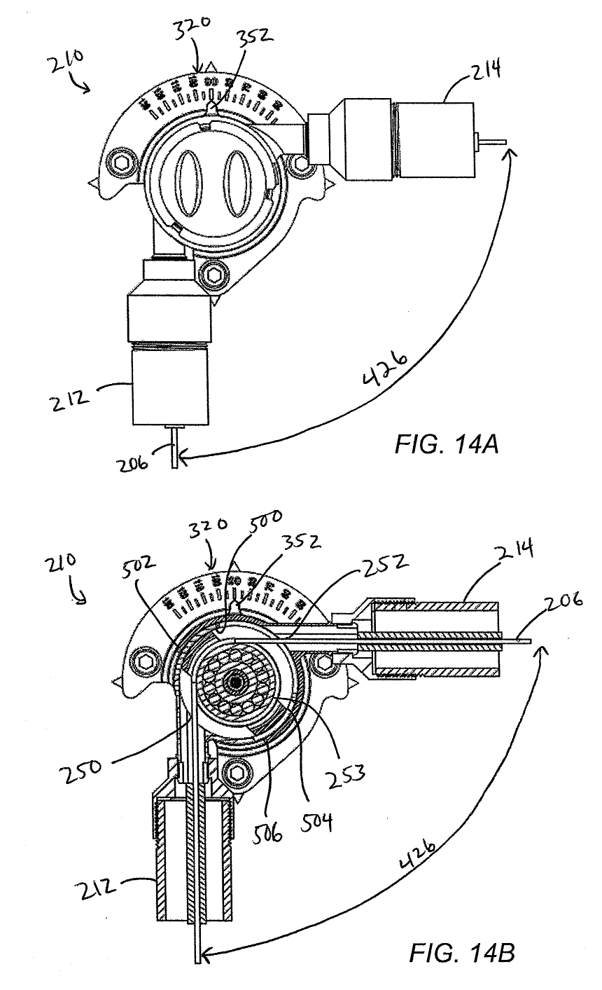

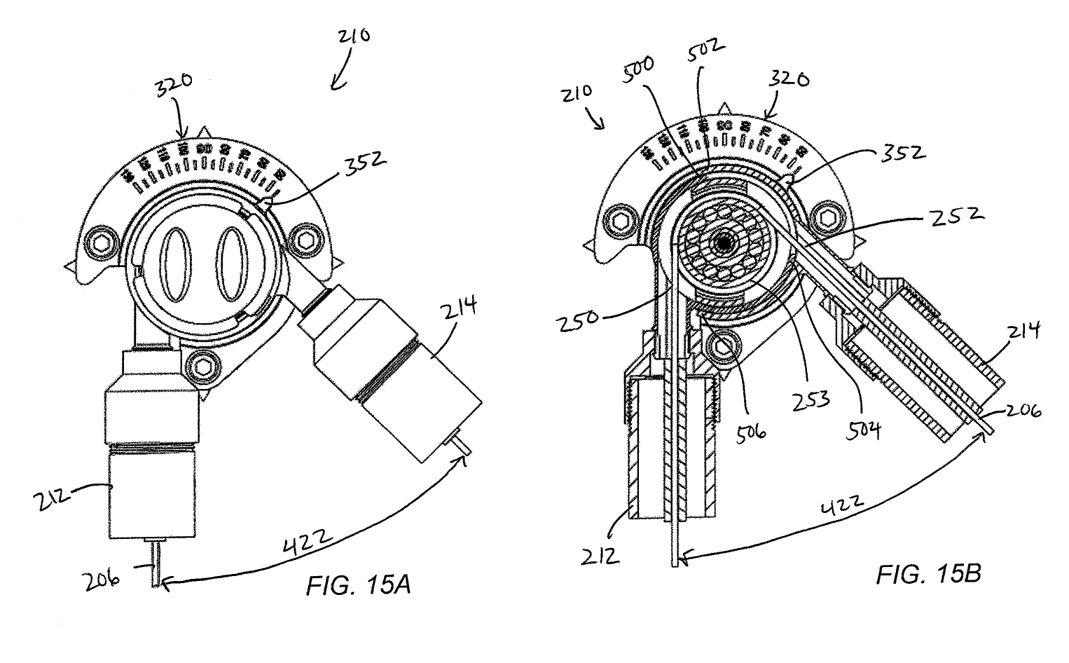

FIGS. 13-15 depict the adjustable pulley assembly 210 configured for different angular separations according to some embodiments of the invention. Briefly, FIGS. 13A and 13B illustrate a maximum separation angle 424, FIGS. 14A and 14B illustrate an optional 90 degree angle 426, and FIGS. 15A and 15B illustrate a minimum separation angle 422. In each case, the angular scale 320 and angular indicator 352 preferably indicate the angle of separation between the conduits and first and second apertures 250, 252. Thus, an operator can easily and precisely adjust the angular separation of the pulley assembly to accommodate a wide variety of conduit networks and line paths.

FIGS. 13-15 also illustrate the varying degrees of overlap between the first wall portion 264 of the first housing member 260 and the second wall portion 266 of the second housing member 262 as the adjustable sidewall 238 is configured for different separation angles. Such overlap can help maintain the environmental integrity of the housing between the first and second conduits. For example, referring to FIG. 13B, a trailing edge 500 of the first wall portion 264 shows a relatively large degree of overlap with a trailing edge 502 of the second wall portion 266 for the maximum separation angle 424. For the same angular separation, a leading edge 504 of the first wall portion 264 shows a relatively small degree of overlap with a leading edge 506 of the second wall portion 266. Referring to FIG. 15B, some embodiments provide a similar but opposite relationship for the minimum separation angle 422. For example, the trailing edge 500 and the trailing edge 502 exhibit a relatively small degree of overlap in FIG. 15B, while for the same angular separation, the leading edges 504, 506 show a relatively large degree of overlap.

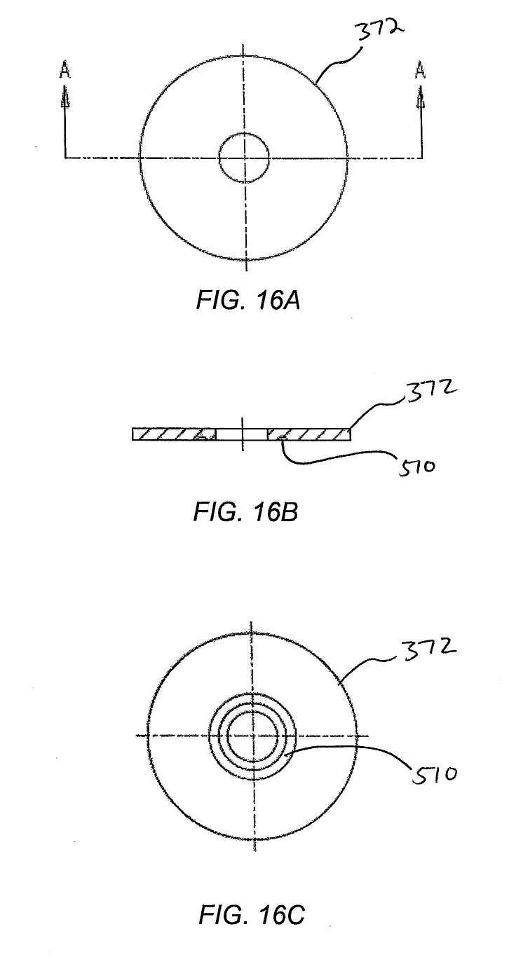

FIGS. 16A-16C show various views of the washer 372 according to embodiments of the invention. Referring to FIGS. 16B and 16C, in some embodiments, the washer 372 includes a biasing member seat 510 configured to receive a portion of the biasing member 360. For example, the seat 510 can comprise a small groove in the washer encircling the center hole of the washer. Referring to FIG. 10, in some cases the upper support post 330 may also include a biasing member seat 512 configured to receive a portion of the biasing member 360.

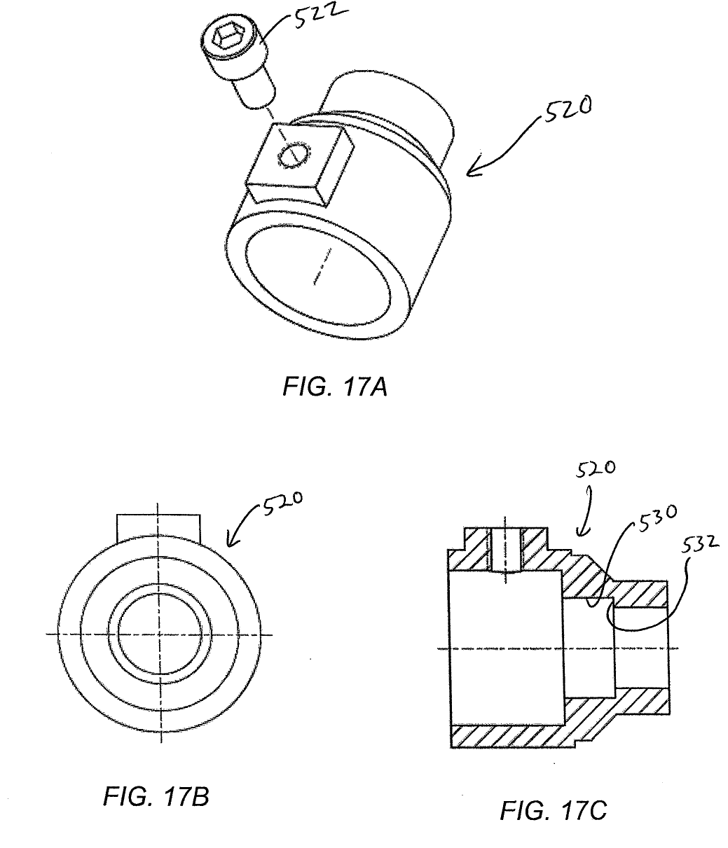

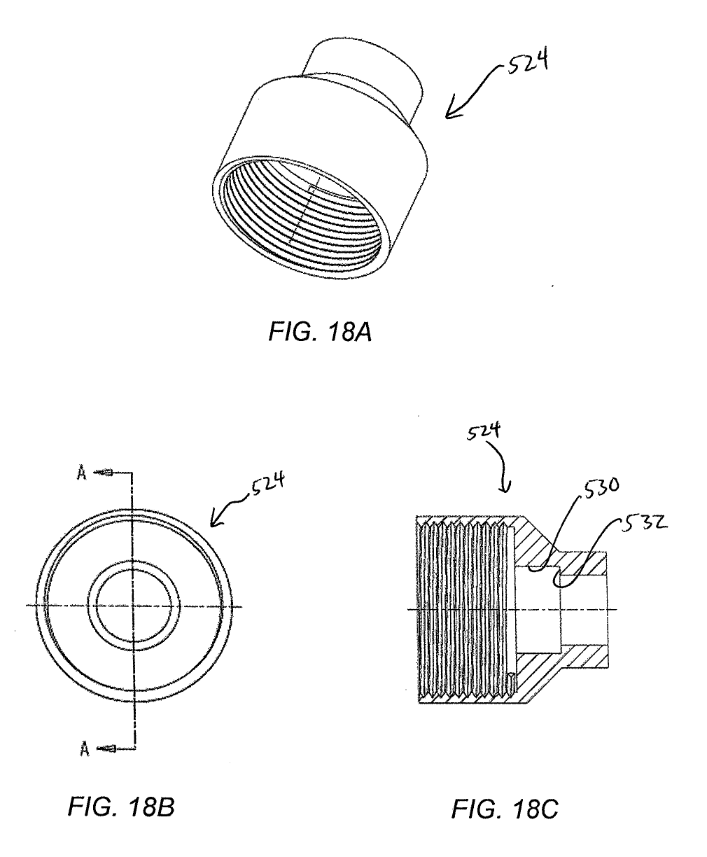

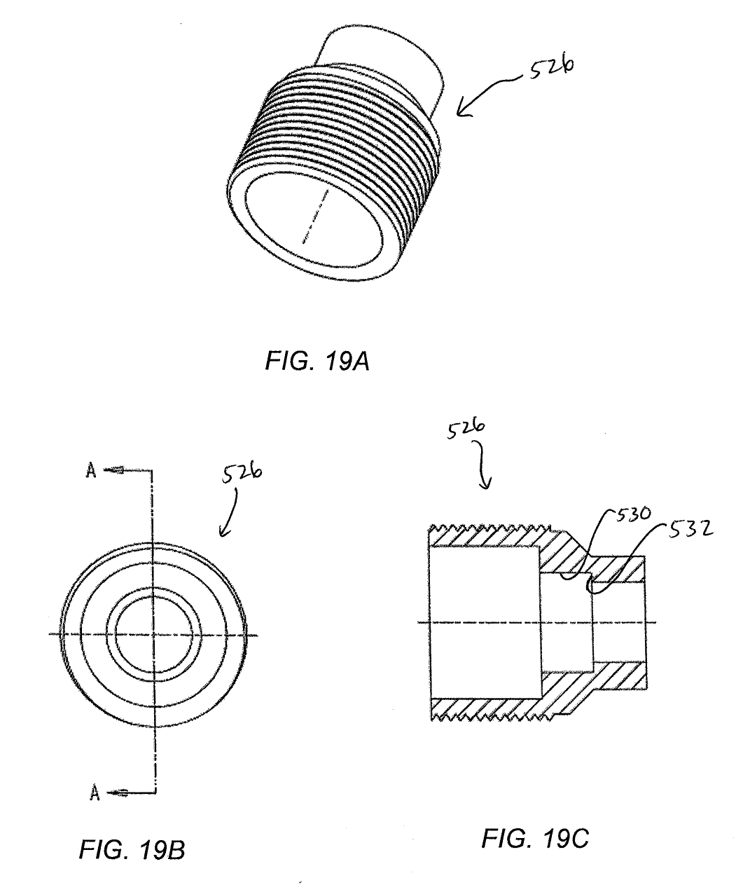

Turning now to FIGS. 17-19, various views of a number of conduit fittings for coupling the pulley assembly to one or more conduits are shown. Advantageously, pulley assemblies according to embodiments of the invention can universally couple to a wide variety of conduits. For example, some embodiments may provide a universal slip-on conduit fitting 520 with a set screw 522 as shown in FIGS. 17A-17C. Some embodiments may include an internally threaded conduit fitting 524 (FIGS. 18A-18C) and/or one or more externally threaded conduit fittings 526 (FIGS. 19A-19C). In some embodiments, each conduit fitting is configured to snap fit onto the universal conduit fitting bosses 310, 350. For example, each conduit fitting can include a small diameter entrance with a cleat relief 530 and a cleat stop 532 for receiving and locking the conduit fitting boss. In some cases, once compressed and inserted, the conduit fitting cleats expand and lock the boss tip into the conduit fitting, resulting is a secure coupling of the various conduit fittings to the conduit fitting bosses and the adjustable pulley assembly.

Returning once again to FIG. 2, in some embodiments of the invention, a method of installing a line activated system (e.g., wire-activated), such as a fire suppression system, is provided. Embodiments of the installation method may be applicable for a variety of line activated systems, including those providing a fire alarm system. In some cases, a method includes providing an adjustable pulley assembly 210 according to embodiments of the invention, and adjusting the angular separation between the first and second apertures of the adjustable pulley assembly to a desired non-perpendicular angle. In some cases, this may include setting the angular separation to one of a discrete number of angles, such as, for example, one between about 45 degrees and 130 degrees. The pulley assembly 210 can then be coupled between a first conduit 212 and a second conduit 214. For example, the pulley assembly 210 is preferably coupled such that the first conduit is coupled to the first aperture of the pulley assembly and the second conduit is coupled to the second aperture of the pulley assembly.

In some embodiments, a line is coupled at a first end to a system actuator, routed through two or more conduits and the adjustable pulley assembly 210 and also coupled at a second end to a system activation mechanism. For example, referring to FIG. 2, the line 206, e.g., a wire, cable, rope, etc., may be coupled to the pull lever 204 at one end, then routed through one or more conduits, including the second conduit 214 and the first conduit 212. The line 206 is also routed through the pulley assembly 210 to change the direction of the line in a non-perpendicular angle between the first and second conduits. At the other end, the line is coupled to a release mechanism of a fire suppression dispenser 202 to allow remote activation of the fire suppression system.

Thus, embodiments of the ADJUSTABLE PULLEY ASSEMBLY are disclosed. Although the present invention has been described in considerable detail with reference to certain disclosed embodiments, the disclosed embodiments are presented for purposes of illustration and not limitation and other embodiments of the invention are possible. One skilled in the art will appreciate that various changes, adaptations, and modifications may be made without departing from the spirit of the invention and the scope of the appended claims.

What is claimed is:

1. An adjustable pulley assembly for routing a line within a line activated system, the adjustable pulley assembly comprising:
a housing comprising
a first housing member having a first aperture providing access between the housing and a first conduit of a line activated system, and
a second housing member having a second aperture providing access between the housing and a second conduit of the line activated system, wherein
the first and second housing members are rotationally engaged about an axis of rotation to provide an angular separation between the first aperture and the second aperture, wherein
the angular separation is adjustable within a range of angles including and extending between a minimum separation angle and a maximum separation angle, and wherein
the housing provides an enclosed compartment connecting the first and second apertures throughout the range of angles; and
a pulley member disposed within the enclosed compartment about the axis of rotation for routing a line through the housing between the first and second conduits, the line extending through the first and second conduits for activating the line activated system.

2. The adjustable pulley assembly of claim 1, wherein the first housing member has a first wall portion including the first aperture, the second housing member has a second wall portion including the second aperture, and the housing comprises a top wall, a bottom wall, and an adjustable sidewall comprising the first wall portion and the second wall portion in sliding engagement thereby allowing adjustment of the angular separation between the first and second apertures.

3. The adjustable pulley assembly of claim 2, wherein the first housing member comprises a first retention member for retaining the second wall portion in the sliding engagement and the second housing member comprises a second retention member for retaining the first wall portion in the sliding engagement.

4. The adjustable pulley assembly of claim 3, wherein the first and second retention members comprise first and second grooves in the first and second housing members, respectively, wherein the first groove engages an edge of the second wall portion and the second groove engages an edge of the first wall portion.

5. The adjustable pulley assembly of claim 2, wherein the first housing member comprises the bottom wall of the housing and a lower support post extending from the bottom wall coaxial with the axis of rotation, wherein the second housing member comprises the top wall of the housing and an upper support post rotationally supported by the lower support post, wherein the pulley member is disposed about the upper support post within the enclosed compartment.

6. The adjustable pulley assembly of claim 5, further comprising a fastener coupling the upper and lower support posts, wherein the top wall comprises a removable cover with an alignment member extending into the enclosed compartment coaxial with the axis of rotation and coupling with the fastener to maintain the upper and lower support posts coaxial with the axis of rotation.

7. The adjustable pulley assembly of claim 1, wherein the first housing member comprises a first friction surface and the second housing member comprises a second friction surface, and the housing further comprises a biasing member to urge the first and second friction surfaces into frictional engagement whereby the angular separation can be set at any of the angles within the range of angles.

8. The adjustable pulley assembly of claim 7, wherein the first and second friction surfaces provide a discrete number of angles within the range of angles.

9. The adjustable pulley assembly of claim 1 wherein the range of angles is about 85 degrees.

10. The adjustable pulley assembly of claim 9, wherein the minimum separation angle is about 45 degrees and the maximum separation angle is about 130 degrees.

11. The adjustable pulley assembly of claim 1, further comprising a first conduit fitting coupled to the first aperture for coupling the housing with the first conduit, and a second conduit fitting coupled to the second aperture for coupling the housing with the second conduit, whereby the housing and first and second conduit fittings provide a closed path between the first and second conduits.

12. A wire activated system, comprising:
a closed conduit network comprising
the adjustable pulley assembly of claim 1,
a first conduit coupled to the first aperture of the adjustable pulley assembly, and
a second conduit coupled to the second aperture of the adjustable pulley assembly, the second conduit oriented at a non-perpendicular angle with respect to the first conduit; and
a line extending through the closed conduit network for activating the wire activated system, wherein the adjustable pulley assembly directs the line around the non-perpendicular angle between the first and second conduits.

13. The wire activated system of claim 12, wherein the minimum separation angle of the adjustable pulley assembly is about 45 degrees and the maximum separation angle of the adjustable pulley assembly is about 130 degrees.

14. The wire activated system of claim 12, further comprising a pull lever coupled to a first end of the line and a release mechanism coupled to a second end of the line, wherein the wire activated system is a fire suppression system and the release mechanism is adapted to release a fire suppression agent upon actuation of the pull lever.

15. An adjustable pulley assembly for routing a line within a line activated system, the adjustable pulley assembly comprising:
housing means for providing an enclosed compartment between first and second conduits of a line activated system, the housing means comprising
a first aperture for accessing the first conduit,
a second aperture for accessing the second conduit, and
rotating means for adjusting an angular separation between the first and second apertures wherein the angular separation is adjustable within a range of angles including and extending between a minimum separation angle and a maximum separation angle; and
pulley means disposed within the housing means for routing a line through the housing means between the first and second conduits, the line extending through the first and second conduits for activating the line activated system.

16. The adjustable pulley assembly of claim 15, wherein the housing means further comprises friction means for setting the angular separation at any of the angles within the range of angles.

17. The adjustable pulley assembly of claim 16, wherein the range of angles includes a discrete number of angles.

18. A method of installing a fire alarm and/or suppression system, comprising:
providing an adjustable pulley assembly having a housing and a pulley member disposed within the housing, the housing comprising a first housing member having a first aperture and a second housing member having a second aperture, wherein the first and second housing members are rotationally engaged to provide an angular separation between the first and second apertures, and wherein the housing provides an enclosed compartment connecting the first and second apertures;
adjusting the angular separation between the first and second apertures of the adjustable pulley assembly to a desired non-perpendicular angle;
coupling a first conduit to the first aperture;
coupling a second conduit to the second aperture;
coupling a line to a system actuator; and
routing the line through the first conduit, the adjustable pulley assembly, and the second conduit to allow remote activation of the fire alarm and/or suppression system.

19. The method of claim 18, wherein adjusting the angular separation comprises setting the angular separation to one of a discrete number of angles.

20. The method of claim 19, wherein the adjusting the angular separation comprises setting the angular separation to an angle between about 45 degrees and 130 degrees.
